(19) United States
(12) Patent Application Publication
(10) Pub. No.: US 2015/0149370 A1
(43) Pub. Date: May 28, 2015

(54) METHOD FOR LAWYERS TO COMMUNICATE TO COURTS

(71) Applicants: Roger W. Klein, O'Fallon, MO (US); Timothy A. Engelmeyer, Chesterfield, MO (US)

(72) Inventors: Roger W. Klein, O'Fallon, MO (US); Timothy A. Engelmeyer, Chesterfield, MO (US)

(21) Appl. No.: 14/089,444

(22) Filed: Nov. 25, 2013

(51) Int. Cl. G06F 17/30; G06Q 50/18

(52) U.S. Cl. CPC G06F 17/30011; G06F 17/30876; G06Q 50/184
USPC 705/311

(57) ABSTRACT

A method for lawyers to communicate to courts has a client browser in bi-directional communication with a web application server and database. The database stores records and procedures for each court system and common functions applicable to any court system. A messaging subsystem provides messages populated with information from database records for delivery through the web application server to the client browser, or user. The method operates upon a docket of criminal cases, typically those without an in person trial. The invention allows real time collaboration between attorneys, prosecutors, and the court staff as modules. The attorney module has a tickler system that reminds the attorney about cases with open documents via email. The administrator module displays defendant data for a case. The prosecutor module generates a quick recommendation for disposition using information about a defendant placed into a template.

### CROSS-REFERENCE TO RELATED APPLICATION

This non-provisional application claims priority to the pending provisional application 61/729,943 filed on Nov. 26, 2012 which is owned by the same inventors.

### BACKGROUND OF THE INVENTION

The method for lawyers to communicate to courts generally relates to courthouse automation and more specifically to automating the opening, review, and disposition of criminal cases excluding in person trial. More particularly, the method operates from a lawyer initiating a case by entering appearance and requesting a recommendation, a clerk managing the case, and a judge disposing of the case upon a computer connected to the Internet.

Until the time of the code of Hammurabi, people resolved disputes exclusively orally in front of judges. Building upon Hammurabi's code, disputes is received resolution more and more using written legal codes administered by judges. The Romans established their legal code and imposed it in various parts of their empire, including the British Isles. As the Roman Empire faded, some of its institutions remained and became part of local government. Following the Norman Invasion of England, judges in England received appointment to the bench of their territory and served in the territory, often far removed from the influence of London. From time to time, the judges gathered in London and exchanged views on areas of the law before them. In time, these discussions made the law common to all in England, hence the Common Law derived from the decisions of judges passed down through cases nowadays published by various reporting services.

Though laws appear in writing and take form in written cases, facts and people vary from case to case. A judge then has to apply the written law to the facts and people before him. The application though of a law may vary slightly from case to case. Cases can be brought at many levels from the national to the local and levels in between. The local level may also include municipal court that usually covers traffic and ordinance violations. As the number of vehicles and drivers has grown, the traffic violations have grown proportionally, and some say exponentially. Such violations may accumulate making hearing each case before a municipal judge impractical because of the shear number of cases.

### DESCRIPTION OF THE PRIOR ART

Over the years, programmers and law practice management consultants have made various practice management systems and courthouse automation systems. The practice management systems provide for deadline tracking, timekeeping, and other related functions in a law office. The courthouse automation systems allow court staff to open, to manage, and to track cases filed is and transferred to a specific court. The federal courts have the PACER system, or Public Access to Court Electronic Records, that allows for attorneys to file cases electronically. The federal court staffs then manage and track the cases on PACER as they progress through litigation. PACER receives documents in PDF form from attorneys, clerks, and judges who create them and then upload them into a case file upon PACER. The PACER system though does not create documents in a case.

In select counties, the counties have incorporated municipalities within them which have ordinances and courts. From time to time, the public violates the ordinances, most often traffic related, and members of the public receive citations or tickets listing the ordinance violation and a court date. As these remain ordinance violations, incarceration as a remedy for the violation appears unlikely. However, the courts still seek to deter repeated violations of the ordinances and to foster compliance with them.

Municipalities have prosecutors by their incorporation statutes. The prosecutors have discretion in bringing cases before a municipal judge and in recommending handling of the cases. Prosecutors, through their clerks and staff, receive the violation tickets for disposition. Because the tickets reflect ordinance violations and prosecutors have discretion with their role, prosecutors manage the disposition of tickets in a timely manner. The prosecutors conserve their resources and bring to trial a much less number of cases than the number of tickets issued. The prosecutors do so, by issuing, for less serious violations, a recommendation to an alternate charge with a fine. The prosecutors expect attorneys to request the recommendations on behalf of their clients. For example, a motorist may have a ticket for driving 5 m.p.h. over the speed limit, an attorney requests a recommendation, and the prosecutor issues a recommendation for improper parking with a fine and court costs. The motorist is retains the ability to accept or to reject the recommendation. Upon acceptance, the motorist pays the fine and the prosecutor closes the case without a trial. A motorist who rejects the recommendation then risks an assessment of points against a driver's license and related insurance premium increase should the ticket proceed towards trial. Though this example has shown a recommendation for a municipal traffic ordinance violation, recommendations may apply to other ordinance violations within the scope of the prosecutor's discretion.

The present invention overcomes the disadvantages of the prior art and provides a method for lawyers to communicate to courts and to manage their practices that allows for creation, tracking, and disposition of recurring cases. The present invention allows lawyers to open cases, request recommendations, and manage the case from their office and allows prosecutors and their staffs to decide upon and to issue recommendations in select cases. The present invention operates in a paper-less environment.

### SUMMARY OF THE INVENTION

Generally, the method for lawyers to communicate to courts has a client browser that communicates in two ways with a web application server that also communicates in two ways to a database. The database stores in excess of 130,000 records. The database also stores procedures for each court system and common functions applicable to any court system. A messaging subsystem provides messages populated with information from database records for delivery through the web application server to the client browser, or user. The present invention operates upon a docket of criminal cases, typically those capable of resolution without an in person trial. The invention allows real time collaboration, that is, a role based work flow, between attorneys, prosecutors, and the court staff as opposed to the existing document system using mail or is portable document format, PDF, files. The invention utilizes three modules: attorney module, administrator module, and prosecutor module. The prosecutor module generates a quick recommendation for disposition using information about a defendant from his attorney placed into a template.

The attorney module requires a defense attorney to enter his state bar number and an electronic signature. The attorney must approve his entry of appearance by clicking upon the CONFIRM button displayed upon his screen. The present invention will operate with a tickler system that reminds the attorney about cases with open documents as the tickler sends an email to the attorney who has subscribed to the invention. The tickler utilizes the statuses of Unconfirmed, Confirmed, and Accepted. Unconfirmed means a case or a document exists upon the invention but an attorney has not yet consented to the case or the document. Confirmed means that a case or document upon the invention has received the consent of an attorney to that case or specific document. Accepted means that the method of the invention has received the attorney's consent to a document and the document itself. The present invention operates upon user fees charged for each transaction to defense attorneys. The present invention allows for electronic mailing of invoices and supports credit card payment for them. In an alternate embodiment, the attorney module supports advertising to subscribers.

The administrator module has a screen that displays defendant data for a case including the ticket number and charge title. Select court systems may adopt the invention voluntarily, usually for cost savings. Other court systems may appear on a list of courts supported by the invention to urge the court systems to adopt the invention officially. This module provides prefilled documents related to a case such as pleadings like a complaint or an answer. These documents already include information from the ticket or other charging is document and information about a subscribing attorney. This module checks new cases for correct information related to the attorney and the case. An attorney not subscribed to the invention may not view documents and an attorney not associated to a particular case may not view those specific documents. However, an attorney associated to the case may thus view the documents of the case. The administrator module operates upon a role based work flow.

The administrator module also operates the security for the present invention. The present invention includes forms based authentication using a security certificate, such as that provided by MS.net. A user, typically a subscribing attorney, logs in under SSL, secure socket layer, encryption. Once authenticated, a user sees a web application as the front end to the invention operating upon a web server. As users are people, sometimes people forget or lose their passwords. When that happens, the invention displays FORGOT PASSWORD to the user and denies the user access. The user may then request a hint of the existing password or a new password. The administrator module includes a password recovery utility that queries a user with preselected questions and reissues a password.

The prosecutor module begins with a secure login screen. The prosecutor may then view an annotated record of a case. The prosecutor may add additional notes to a case. Over time, the prosecutor builds a forms bank or templates for often used documents and the forms bank remains with the present invention. The forms bank allows for “quick recommendations” that the prosecutor uses to increase the number of recommendations issued in a time interval. Once the prosecutor reviews a case and the pleadings, the prosecutor may issue a recommendation to a defense attorney.

There has thus been outlined, rather broadly, the more important features is of the invention in order that the detailed description thereof that follows may be better understood and that the present contribution to the art may be better appreciated. The present invention also includes a rolling backup of the three modules typically each hour, interactive communication between the judicial branch, that is, the administrator and the attorney subscribers, subscription access to avoid entry into the invention by pro se persons, interfacing with Sharepoint™ by Microsoft® and PDF generating software utilities and with asynchronous Java script XML or AJAX. The invention provides private case management for attorneys and law firms where the management allows for creation of pleadings and control of them. The management has an electronic link to court systems selected by the attorney. The present invention operates upon a world wide web platform which allows access from locations outside of an office. Within its functions, the present invention uses tabs and folders that lead to communications with prosecutors and others through an instant message system, a chronology/diary/alibi sheet about a case, and creation of select documents. Within its procedures, the present invention links the documents and messages to a case through an index that tracks created documents and emails of a case. The functions of the invention also provide a real time calendar and the procedures of the invention perform backups of the entire database and allow users to backup their portions of the database. The backup procedures also allow users to select and to customize the purging of email and documents. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with is the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a method for lawyers to communicate to courts that allows authorized parties to initiate, manage, and dispose of a case without use of paper records.

Another object is to provide such a method for lawyers to communicate to courts that allows a clerk and a judge to utilize templates to dispose of select cases.

Another object is to provide such a method for lawyers to communicate to courts that allows a court system to accelerate its case disposition at less cost than in present systems.

Another object is to provide such a method for lawyers to communicate to courts that allows lawyers to manage their open cases from filing to closing.

Another object is to provide such a method for lawyers to communicate to courts that allows for interactive communication between the judiciary and the attorneys.

Another object is to provide such a method for lawyers to communicate to courts in real time without the need for postal mail or PDF emailing.

These together with other objects of the invention, along with the various features of novelty that characterize the invention, are pointed out with particularity in the claims annexed to and forming a part of this disclosure. For a better understanding of the invention, its operating advantages and the specific is objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 provides a flow chart of the present invention;

FIG. 2 shows a screenshot of the operating buttons of the invention;

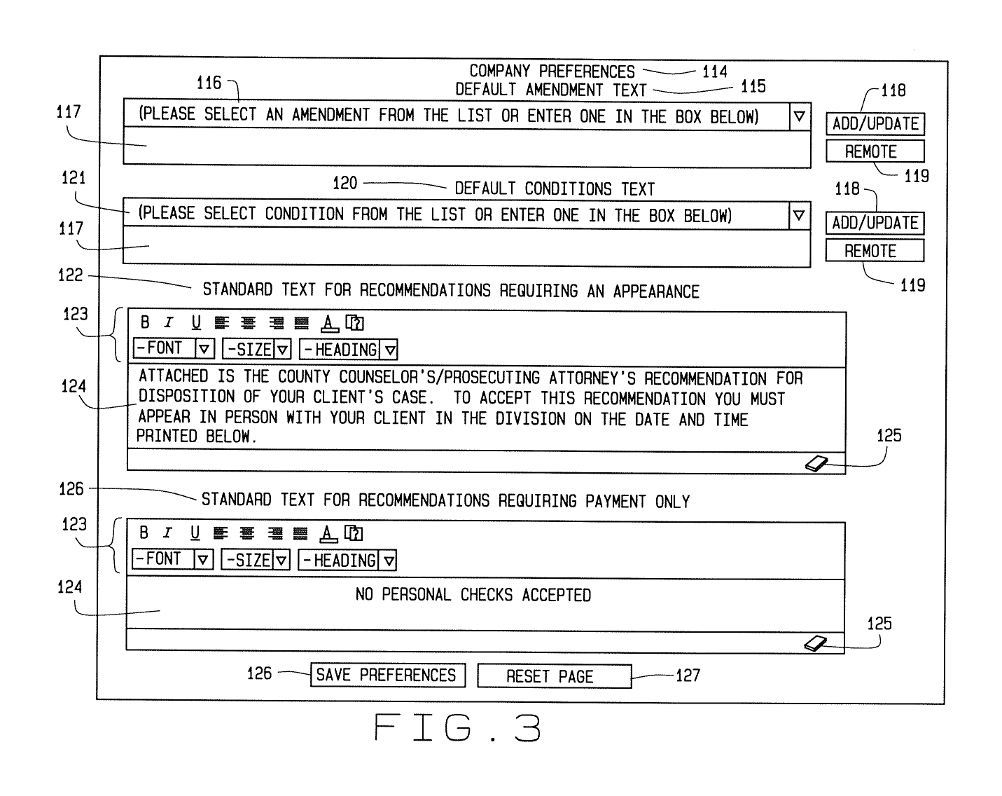

FIG. 3 shows a screenshot of prosecutor's recommendation template of the invention;

FIG. 4 describes a screenshot of the user administration screen of the invention;

FIG. 5 illustrates a screenshot of a case status listing;

FIG. 6 provides a screenshot of a template for opening a case; and,

FIGS. 7A and 7B show two halves of a screenshot of a template for issuing a recommendation.

The same reference numerals refer to the same parts throughout the various figures.

### DESCRIPTION OF THE PREFERRED EMBODIMENT

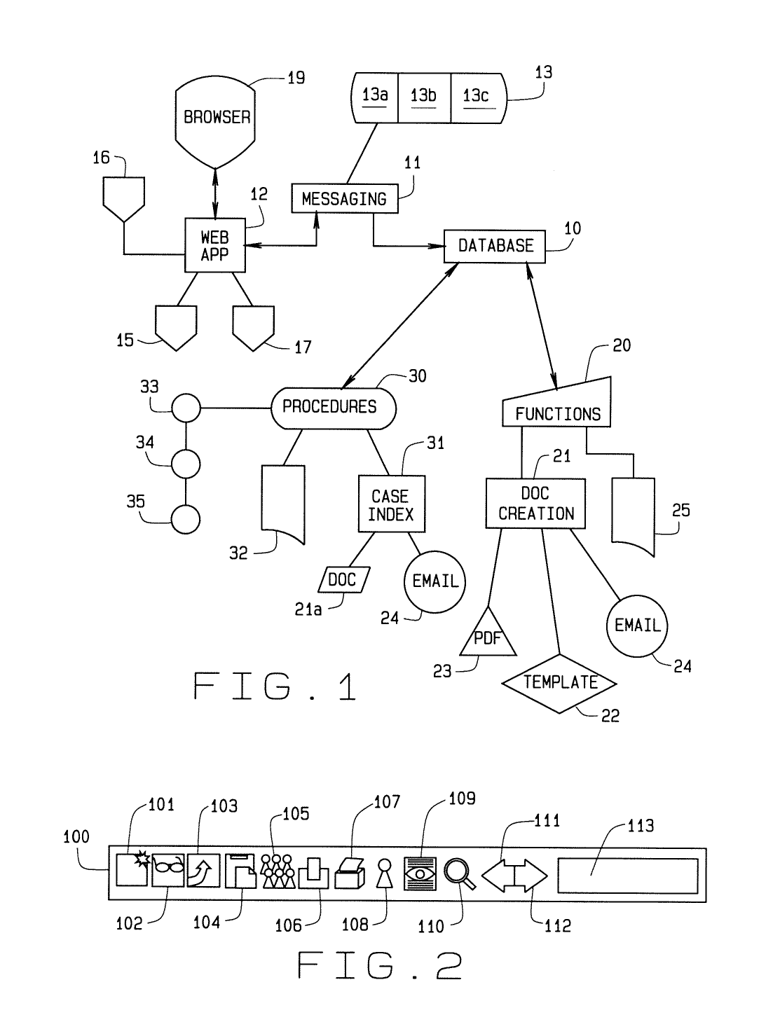

The present art overcomes the prior art limitations by providing a method for lawyers to communicate to courts and to manage their practices, primarily in criminal cases such as ordinance violations. FIG. 1 shows the flow of the present invention beginning with its secure database 10 that generally locates upon a remote computer server. The remote computer server is generally spaced away from the user a substantial distance but communicate to the user over the internet. The database allows the three classes of users, as at 13, attorneys 13a, administrators-clerks 13b, and prosecutors 13c, to fulfill their roles in the disposition of a case. The database begins communications to its users through a messaging subsystem as at 11. The messaging subsystem provides two way communication from the database 10 to a web application server 12, or webapp. The webapp allows users to interact with the database in an efficient and usable manner such as through a web browser 19. The users communicate in real time, that is, without the lag in emailing of PDF files, faxing documents, or mailing documents. The browser provides a visual display of information and instructions to a user for operating the invention as later described. A user may utilize a typical browser, such as Mozilla Firefox, Microsoft® Internet Explore, and Google® Chrome, and the like.

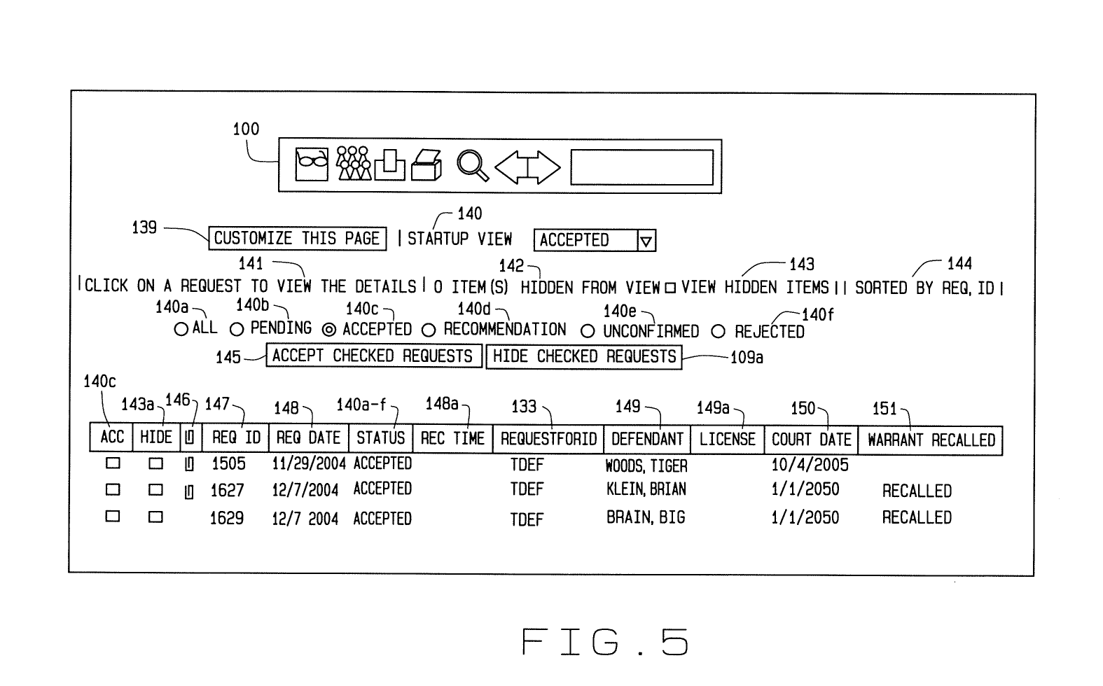

The webapp 12 also has inherent functions including user account access, as at 15, password recovery, as at 16, and fee calculation as at 17. The user account access establishes a relationship between the user and the invention. The user account undergoes authentication using a forms based method such as MS.Net with a security certificate, typically an SSL, that follows a user during the entire time of being logged in. The relationship begins with entering the user's name and associating that to a username and password as later shown in FIG. 4. The password recovery function collects answers from the user to three questions and stores those answers. Upon a user failing to enter a password correctly after three attempts, the password recovery function prompts the user to answer the three questions. Successful answers to the three questions allow a user further access into the invention. Unsuccessful answers deny access to the aspiring user. The fee calculation function determines the number of transactions by a user through the webapp to the database. Then it applies a rate, typically a fee per transaction, to the number of transactions and debits the user's account for the charge. The debiting can be performed through is a credit card, ACH transfer, allotment, monthly invoice, and the like. If the debiting fails, the fee calculation function sends a warning to the user. After three calendar days without proper payment, the fee calculation function sends a command to the password recovery function for it to disable the user's password.

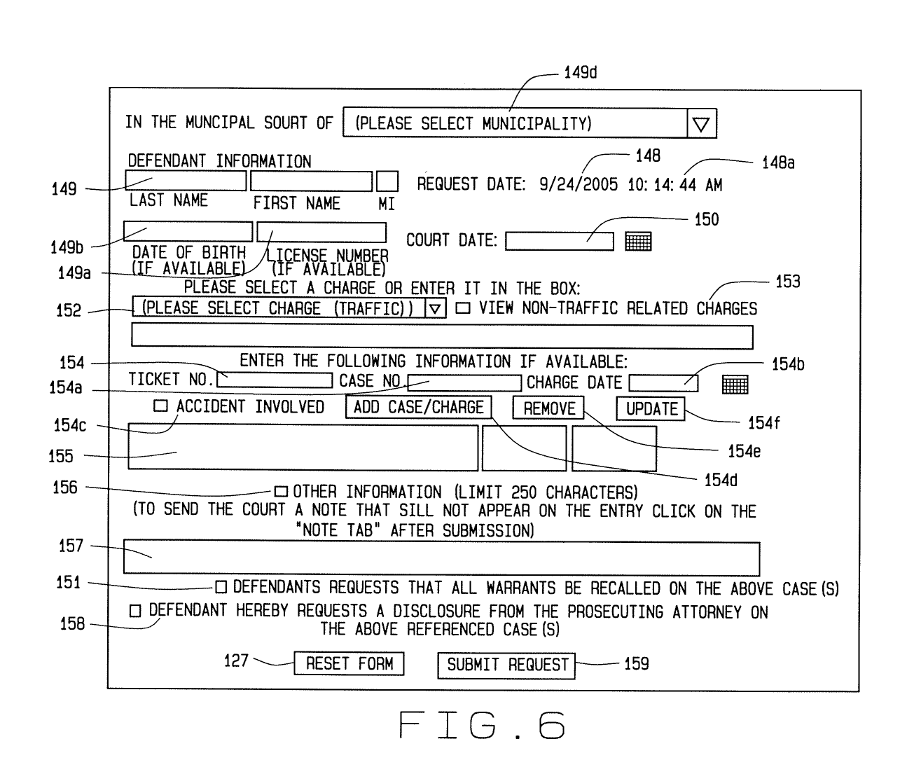

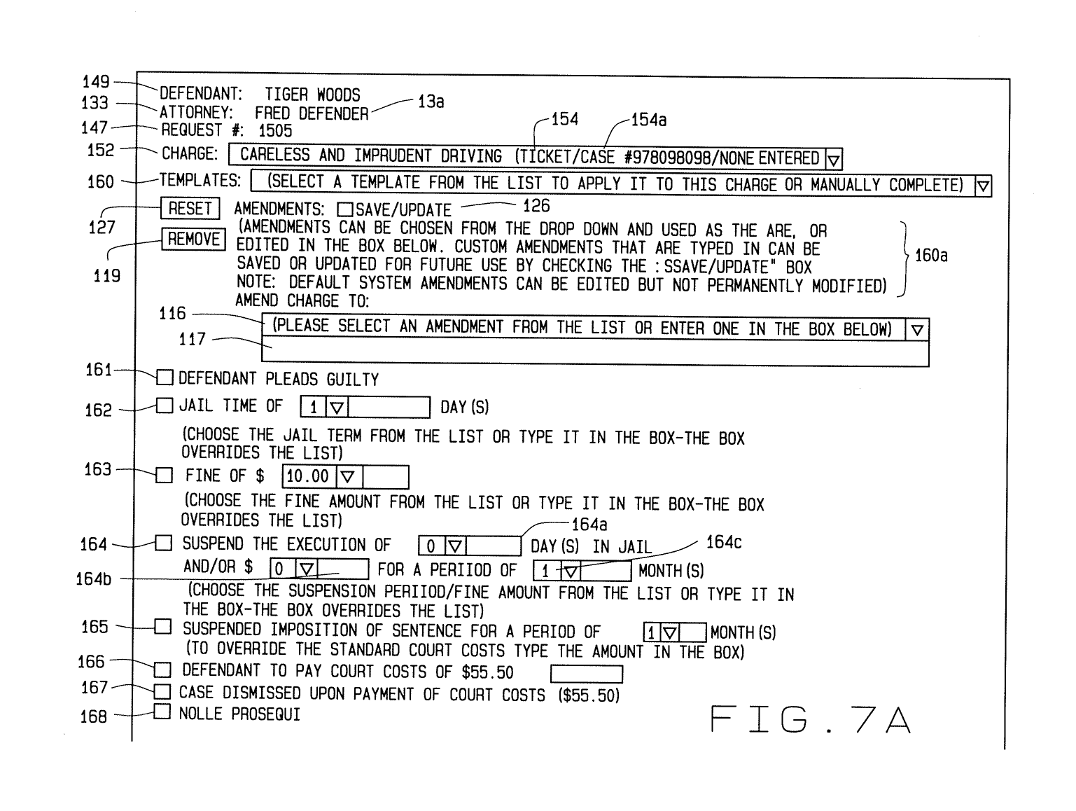

Upon successfully entering a password, the user then accesses the database 10 to operate the invention. The database performs two groups of tasks: functions 20 and procedures 30. The functions 20 generally create and process data, formerly in document form, from the user through the database to various other users such as the prosecutor 13c, clerk 13b, and the defense attorney 13a. Any of the three identified users may utilize the functions 20 to send data to the other users. The functions begin with creating a document as at 21. This document, primarily in electronic form, though of a format familiar to the users, establishes a case for the clerk to receive and the prosecutor to decide. Typically a user, or defense attorney, enters an appearance and requests a recommendation to start a case as later shown in FIG. 6. The document creation function assigns a number to a new case that it keeps until disposition by the prosecutor. The user may utilized a template as at 22 to create the opening documents for a case. The template also includes later documents for the clerk and the prosecutor. With a template filled, the document creation function renders the data into a pre selected format, as later shown in FIG. 5, into a fixed form such as a PDF file as at 23. The document generation function then transmits the PDF file to the other users through the database 10 via email as at 24. A clerk may also merge or attach discovery documents, police reports, and the like to a case. With a document created and sent to users, a case enters its prosecution phase. During that phase various events happen upon a schedule set by statute, circuit court rule, such as a County Court, and local rule, such as by a prosecutor or judge. The functions 20 allow for tracking of a case's schedule through a calendar module as at 25. The calendar tracks the scheduled events in a case, such as hearings and meetings, via direct user entry, through its own date template, and through an automated procedural date set.

Along with functions 20, the database 10 also performs select procedures as at 30. These procedures move a case along towards its disposition and track the position of the case towards that goal. The procedures include a case index 31 that generates and assigns an alphanumeric code to each case upon its creation by a defense attorney user 13a. An attorney user 13a, may log into the invention using his bar number or an electronic signature. The invention allows an attorney to utilize an electronic signature later when submitting requests. A clerk user 13b may cross reference the code to a ticket number as received the issuing officer. The clerk also checks requests for the correct style of pleading and sends a message to an attorney of a defect in the pleading surfaces. The case index attaches an electronic record to the code of each case. The electronic record packages the documents as at 21a previously created through the functions as at 21 and the emails previously created as at 24. The case index in conjunction with the calendar sends select emails to the users about the status of a case at predetermined intervals or events. The procedures also include a transaction list for each case as at 32. The transaction list also has the name of a diary or alibi sheet. The transaction list identifies the documents and emails of a case in an order, typically chronological order, and alternatively in defendant name order. The database through the procedures also has a backup as at 33. The backup duplicates the contents of the database in a second file stored remotely from the server hosting the database and the webapp. The backup may occur on a fixed interval automatically, such as daily, or is alternatively a clerk user 13b may manually set the backup interval. The backup of the invention's database operates as a rolling backup with a transaction log backed up hourly. The backup 33 also has the ability to archive select data as at 34. The archive procedure removes certain data about cases closed a certain number of years from the database to a third file. The third file is also stored remotely. Eventually, a closed case reaches a second certain age and the closed case has no further effect upon the defendant or the municipality. Upon a case satisfying those two criteria, the archive activates a purge procedure 35. The purge procedure removes select closed cases permanently from the archive beyond the ability of forensics to retrieve the case. Performing archives and purges on a regular basis reduces the long term data storage requirements of the database for each municipality or court that utilizes it.

Upon a user accessing the invention as in 12, the user's browser as at 19 displays a toolbar 100 to assist the user in operating the invention through the database 10. The toolbar has a plurality of buttons for a user to press utilizing a computer mouse, not shown. The buttons include the following. A new request button 101 that is only available if the currently logged on user works for a law firm and is in the “Defender” role. A view request button 102 that is available to all users of the site. Clicking on this button brings up a list of the current requests for your company. This is the same list that is presented when first logging on to the site. An upload document button as at 103 allows for attaching one or more documents, 21 a, to a request and is available to all users of the to site. A paste document button, as at 104, then allows a user to paste portions of text into documents and attach them to a request. All users of the site may access the paste document button and the screen of this button also serves as a basic word processor for creating ad hoc documents. Next, a user admin button, as at 105, then allows certain select users to manage any user's account. Select is users activate this button by being currently logged in an administrative role for the site, such as “MuniAdmin”, akin to 13c, “FirmAdmin”, akin to 13a, and “Administrator”, akin to 13b.

A company admin button, as at 106, lets a user manage company specific information established in the account setup as at 15. Select users activate this button by being currently logged in an administrative role for the site, such as “MuniAdmin”, akin to 13c, “FirmAdmin”, akin to 13a, and “Administrator”, akin to 13b. A print button, as at 107, appears on this toolbar 100 if the current document being viewed has a “printer friendly” version available. Printing a document through this button provides a clean paper copy of the document without the added Web page information commonly printed in a margin. An admin button as at 108 provides the ability to edit and repair any portion of the invention. The admin button 108 only operates for a user logged in as the site administrator. Then a hide from list button, as at 109, appears on this toolbar 100 when a user views a document pertaining to a request that has reached a final resolution, such as a recommendation being issued or the request being rejected by the court. A user clicking on this button will hide the request from the request List, that is, the specific request does not visibly appear upon a user's screen, though the request remains in the case index 31. Upon clicking the hide from list button 109, the invention then changes the appearance of the button to a show in list button. Next, the show in list button, as at 109a, appears visible when viewing a document pertaining to a request that has been hidden. Clicking this button will reveal the request and the hide from list button 109 returns to view.

With various data, names, and case numbers being used, user will seek to find them from time to time. The invention provides a search button, as at 110, that all users may see and provides to any of them the ability to search for a is particular defendant, client, or transaction by entering particular search data such as the Request ID, Defendant Last Name, Defendant First Name, License No., Case No., Ticket No., and the like. Performing such a search will locate the requested information, in the case index 31, even if the case has hidden status. The present invention often displays cases in list format as later shown in FIG. 5. A user may seek to move within the list using the previous case button 111, shown as a left arrow, and the next case button 112, shown as a right arrow. These two buttons provide the user the ability to sequentially move to the previous or next case in the current request list. This eliminates the need to return to the request list to select the next case to perform an action on. Browsing the request list occurs as upon a continuous scroll so that when a user reaches the end of the list, it will start browsing from the beginning of the list again. When using the search procedure 110 mentioned above, the previous case button 111 and the next case button 112 allow a user to browse the results of the search for a manual match to the sought after case, name, or request. And to the right of the next case button, the toolbar 100 includes a search box 113 that receives alphanumeric input from a user which serves as the argument for a search command into the database.

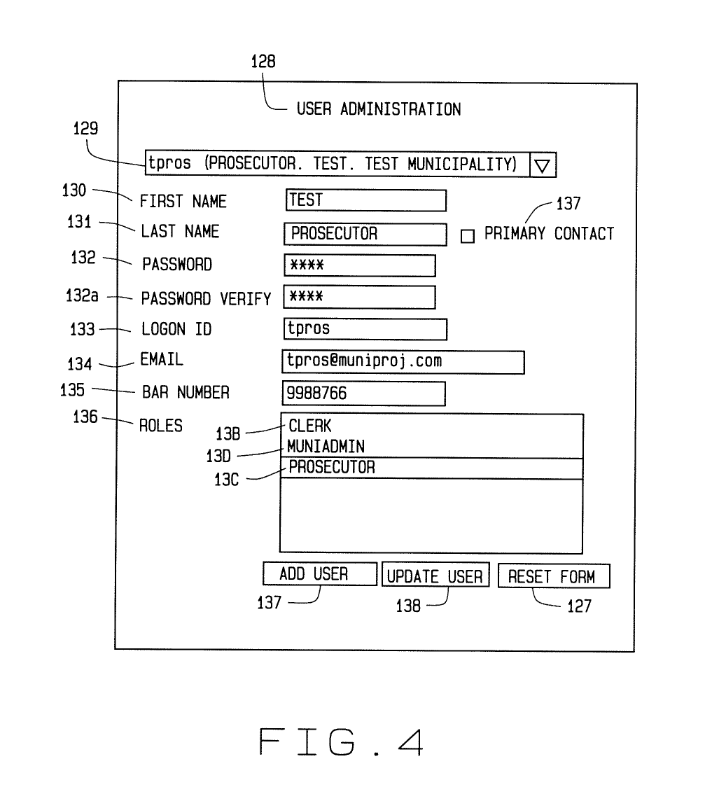

Upon selecting the view button 102, a user logged in as a clerk or prosecutor views the company preferences screen 114 as in FIG. 3. This screen allows for entry, editing, and capture of text that recurs in the documents of a clerk or a prosecutor. The company preferences screen provides a section for default amendment text as at 115 where an amendment alters a municipal charge to a lesser offense typically. This section includes a title bar as at 116 that has instructions and a pull down menu for previously loaded blocks of text. The previously loaded blocks of text appear in the display window 117 when a title is selected through the title bar 116. For the first block of text loaded and is later additional blocks of text, the company preferences screen has an add/update button as at 118 generally towards the right of the display window. This placement catches the eye of a user who reads from left to right. Should a block no longer be needed, a user highlights the block with a mouse and then clicks a remove button as at 119. The remove button then instructs the database to delete the block.

Though a lesser offense appears favorable to a defendant, a prosecutor may impose conditions in an amendment. The company preferences screen 114 allows a prosecutor to add conditions as at 120. Such conditions are within the ordinances and statutes involved in a case and within the prosecutor's discretion. Prosecutors thus have flexibility and creativity in their conditions. This section includes a second title bar as at 121 that has instructions for conditions and a pull down menu of previously loaded conditions in text form. The previously loaded blocks of text appear in the display window 117 when a condition title is selected through the second title bar 121. For the first condition loaded and later additional conditions, this portion of the company preferences screen also has an add/update button as at 118. As above, the add/update button has its placement at the right as shown which catches the eye of a user who reads from left to right. Should a condition no longer be needed, a user highlights the condition with a mouse and then clicks a remove button as at 119. The remove button then instructs the database to delete the condition.

But not all matters can be reduced to a lesser offense dispensed with by mail. Select matter dispositions may still required the appearance of a defendant, or alternatively, his defense counsel. The company preferences screen 114 has a portion for text related to recommendations mandating an appearance as at 122. This portion of the screen includes a condensed set of word processing functions as shown at 123. These functions include the abilities is to adjust typeface, line spacing, and numbering typically required in court documents. Beneath the word processing functions, the portion 122 has a window 124 that displays the text as entered by the user, typically the prosecutor 13c. Though this figure shows sample text, other text may be provided by the prosecutor at his discretion. In writing customized recommendations, prosecutors may have to revise text. A prosecutor revises text by highlighting a portion of the text with a mouse and then clicking an erase button as at 125. The erase button then removes so selected text.

Other matters can be dispensed with a payment of a fine by the defendant. Beneath the mandatory appearance section 122, the company preferences screen 114 has a portion for text related to recommendations of fine payment as at 126. This portion of the screen also includes a condensed set of word processing functions 123 and a window 124 that displays the text as entered by the user, typically the prosecutor 13c. Though this figure shows sample text in bold print, other text may be provided by the prosecutor at his discretion without bold print. In writing customized recommendations of a fine payment, prosecutors may have to revise text, also through the erase button 125 as described above.

Having viewed the various sections and portions of the company preference screen 114, a user may have made changes or edits to any one of them. To post the changes or edits into the database, a user must save them by clicking the save preferences button as at 126. Upon clicking the save preferences button, the database accepts the text of the sections and portions for recurring use in various cases as selected by the clerks 13b and the prosecutors 13c subsequently. Sometimes, changes or edits may become encumbered or burdensome where a cleaning of the slate benefits a user. To do so, a user clicks a reset page button 127. Upon clicking the reset page button, is the windows 124 become blank again and ready for revisions.

Various users 13 access and operate the invention through their browsers 19, webapp 12, and related functions as at 11, 15, 16, 17. The invention defines its authorized users through a user administration screen as at 128 in FIG. 4. This screen begins with a list of default users as at 129 such as municipality 13b, 13c, and law firm 13a. This list has a drop down menu portion for an administrator to select for the appropriate class of user. Upon selecting a class of user, the screen displays additional fields for input of data to establish a bona fide user 13 of the invention 1. The additional fields include a first name field 130, a last name field 131, a password field 132 and a verify the password field 132a, a logon ID field 133, an email address field 134, a bar number field 135, and a roles portion 136.

The first name field and the last name field allow for entry of letter characters of a person's name. Preferably these two fields allow for up to 25 characters and automatically capitalize the first letter of each field. The password field 132 accepts a combination of at least eight alphanumeric characters with at least one letter and at least one number. The password verify field 132a requires the user to enter the password again from field 132 which confirms that the user has keyed in the characters correctly and can remember the password. Unlike other fields, the password characters do not display in the password field 132 and the password verify field 132a. The database now associates a password to the user's personal name. For additional security, the screen requires a logon ID 133 with a default logon ID provided as first initial and last name of the user from those two preceding fields. At the discretion of a site administrator, a user may selected a logon ID of their choice. For communications from the database to a user and between users associated to a case, this screen requests a user's email address in the email field 134. This is field allows for up to 25 characters including the @ and .symbols. Depending upon the user type selected earlier, as in 129, this screen requests a bar number as at 135. The typical users for this include attorneys from a law firm, 13a, and the prosecutors from a municipality, 13c.

Also, based upon the type of user select, this screen displays roles as at 136. For a municipality, the invention foresees the roles of clerk 13b, municipal administrative person as at 13d, and prosecutor 13c. The screen permits a site administrator to select multiple roles by using the CTRL key upon a typical computer keyboard. For a law firm, the invention has the roles of attorney 13a and staff (not shown). Having entered the previous requested information, a site administrator creates a user for the invention by clicking an add user button as at 137. Upon clicking the add user button, the database 10, password recovery 16, and account 15 operations receive the data from the screen and create a user's presence in the database which a user then accesses by the Logon ID and password he enters. From time to time, a user may want to change data about him, such as the password. A user may change his data by requesting the site administrator to open the user administration screen 128 to view the user's data. The user then provides the new data which the site administrator keys into the appropriate fields overwriting previous information. The user then reviews the updated data and clicks an update data button as at 138 to send the revised data to the database as before. And from time to time, a user record may become encumbered or have other issues so much that the record requires recreation. A site administrator may then remove a user from access to the database by clicking the reset form button as at 127. Doing so removes the data once associated to a logon id and lets the site administrator create a new user from the beginning.

FIG. 5 shows a screenshot upon after conducting a search 110 through is the toolbar 100. The search results appear on a screen display in tabular form with various settings as the header of the table of information. The header includes a customize page button 139, a start up view menu as at 140, and an instruction as at 141. Upon clicking the customize page button 139, a user may adjust the columns of information, later described, that display upon the screen and their order of display from left to right. Upon establishing a page layout, a user may save the layout by clicking the customize page button again which saves it under a name provided by the user. The page name then appears in the start up view menu 140 to the right of the customize page button. The start up view menu lists various page names and also criteria upon which default searches into the database may be performed by a user. The criteria will be later explained. The customized page provides information in tabular form and includes an instruction as at 141 to guide a user to see the information of a particular case. The instruction here shown guides the user to click a request in the table to see the details of the request. As mentioned above, a user may elect to hide, as at 109, certain cases or requests. The table in the screen shot of FIG. 5 identifies the number of hidden items as at 142 to prompt a user to consider requests not shown on the screen. Should the user desire to view the hidden requests, a check box as at 143 allows the user to bring the hidden requests back into view. The table of information has various columns and statuses, as later described, however a user may select a status for sorting the requests and the screen shot provides a reminder of that sort criterion as at 144.

The statuses of a request include the following: all 140a, pending 140b, accepted 140c, recommendation 140d, unconfirmed 140e, and rejected 140f. The all status calls up requests for display that have not been hidden. The pending status calls up requests that the municipality and its staff have not yet closed. The accepted status, shown here, calls up requests where a defendant has accepted a recommendation, typically upon payment of a fine or other lesser penalty than initially charged. The recommendation status occurs before the accepted status and shows recommendations issued to attorneys for defendants but not yet accepted. The unconfirmed status shows requests without a recommendation received yet or requests requiring additional information from any party involved. And the rejected status shows a request that the prosecutor has rejected request for a recommendation. Rejections occur because of defects in a request on behalf of a defendant from an attorney to the prosecutor, an issue in a properly filed request, an offense no longer suitable for recommendation, and the like. Each status has a radio button adjacent to it, here shown towards the left, that allows a user to sort the tabular information and the sort criterion appears as at 144. Typically, an attorney user 13a confirms or approves his entry of appearance upon filing of a case or request with the invention. An incomplete case or request triggers an unconfirmed status in the database. The invention also sends an email to an attorney user regarding any unconfirmed or un-submitted cases and requests. The email operates from a tickler system that checks the database on an interval for incomplete requests.

Having seen some requests, a user act on requests in the table. A user may accept requests as at 145 or hide requests as at 109a. The button 145 allows a user to accept requests that the user has designated as later described while the hide button 109a allows a user to hid requests of the user's designation that the user does not want to see going forward.

The table of information in this screenshot has select columns. This description proceeds from left to right as in FIG. 5. The first column provides a check box for a user to accept, as at 140c, one request. The second column, to the right of the first column, also has a check box but for a user to hide a request as at 143a. Requests that become hidden no longer appear on the screen but do increment the count of hidden items as at 142. The third column, as at 146, to the right of the second column, provides an indicator for supporting documents associated with a request. The supporting documents merge with the case file and usually come from police reports, discovery, and the like. Here the indicator appears as a paperclip, though the inventor foresees alternate symbols. The fourth column to the right of the support document indicator has the identification number of a request, as at 147, or request ID. The database tracks all of its requests in serial number order assigned sequentially. Preferably the request ID has four digits however, the inventor foresees additional digits in the serial number for municipalities with higher volumes of cases. Each request also has its request date as at 148 that indicates the filing date of the request, that is, the date of its receipt by the municipality, typically the clerk. To the right of the request date is a column for status, as at 140a-f, as described above. A user, such as a prosecutor, sets the status of each request by opening each and reviewing it. The seventh column, that is, to the right of the status column, provides the recommendation time as at 148a. The recommendation time shows when the prosecutor, or his authorized agent, such as a clerk, issued a recommendation for a request. Adjacent to the recommendation time column, the table has the requestor ID column as at 133 that identifies who has submitted the request, such as one of the users, 13, usually a defense attorney 13a. Each request also has a defendant person associated to it as at 149. The defendant person has his or her name displayed, typically last name before first name on the same line as the associated request ID. Typically, one defendant name is listed. In the event a matter has multiple defendants, each defendant has a separate request ID with individual names. Adjacent to the defendant column 149 is a license column as at 149a. The license column allows for a user, such as a defense attorney, to enter a defendant's driver's license number. The license number serves as further identification of a defendant and also allows the municipality, or its designee, to procure the driving record of a defendant from the state traffic infringement database. Adjacent to the license column, the eleventh column provides for noting the court date as at 150 of each request. Initially, the ticketing officer places the court date on a ticket. Upon a defendant presenting a ticket to his attorney, the attorney is made aware of the court date and may enter it into the database during creating and submitting a request. A user, such as a prosecutor, may then sort requests by date to find the oldest requests or those request for a certain court date. After a defendant accepts a recommendation, the prosecutor, through his clerk, completes the bargain and recalls any warrant related to the request as at 151. However, should a defendant not accept the recommendation or other reason make the request become rejected, as at 140f, the request ID will show blank in the warrant recalled column. Having described these twelve columns, a user may sort the requests based upon any of the twelve columns. The database supports such sorting of requests through its webapp 12 that displays the information to the browser of the user as at 19.

Upon clicking the new request button 101 upon the toolbar 100, an attorney or law firm user creates a request through the screen shown in FIG. 6. An attorney 13a, or other law firm user, creates a request by entering the defendant's name as at 149. The name format is in three windows of last name, first name, and middle initial. If available, the user also enters the defendant's date of birth as at 149b and the defendant's driver's license number as at 149a. The name and license numbers feed into the table of information previously shown in FIG. 5. The user also selects a court from a drop down menu adjacent to “Court Of” in FIG. 6 as at 149d. The database then provides a current date as at 148 and a current time as at 148a that the database then associates with the request. Beneath the date, the user enters the court date as at 150 usually from the ticket itself presented by the defendant or a statement by the defendant. The user then selects at least one charge from a drop down menu as at 152. Multiple counts or charges can be inserted in the charges section through the menu 152. The charge can be selected from either the traffic offenses drop down selection list, 152, or by clicking on a non-traffic related charges check box as at 153 and the list will display non-traffic related charges programmed into the database. If the charge sought by the user does not appear in the drop down selection list, the user may enter, or type, the charge in the line below the drop down selection list. Following selection of a charge, the user enters the ticket number as at 154, the case number as at 154a, and the charge date as at 154b. The user does so with a combination of a computer mouse and keyboard. The ticket number, case number, and charge date are generally found upon the ticket. The user may also check a box as at 154c if the ticket involved a traffic accident. After selecting or entering the charge(s) and entering the data on each charge (i.e. ticket number, case number, offense date), the user then clicks an “Add Case/Charge” button, as at 154d, after each charge to insert that charge into the charges section. The charges associated with a ticket then appear in a charges window as at 155, in list form. If a user seeks to remove a charge from the list, the user selects it by clicking on it with a mouse cursor, and then clicking a “Remove Case/Charge” button as at 154e. If after entering a charge, the user would like to modify or change the data just entered, the user selects the charge by clicking on it, and the data fields above the charges list will be repopulated. The user can then make the changes in those data fields by clicking an “Update Case/Charge” button as at 154f. Upon doing so, the database will update that charge with the changes in the charges list.

From time to time, a charge has unusual attributes. Additional information about a charge can be added to a request 147 by a user clicking an “Other Information” check box as at 156, and then typing the desired text in a text box below as at 157. The text box allows information up to 250 characters. The information typed in this section will appear on the attorney's Entry of Appearance and Request for Recommendation. If a user would like to submit information to the court or prosecutor not suitable for appearing on the Entry, then use the “Notes Tab” after submission of the Request. A user may also utilize the “Upload Document” and “Paste Document” features to submit additional documentation. The screen also includes a check box for a defendant through his attorney to request recall of warrants connected to the ticket, as at 151. The attorney checks the recall box, as at 151. Through his attorney, a defendant may also request disclosure from the prosecuting attorney by checking the box as at 158. After entering the preceding information into the database, a user may have to clear the information for many reasons. The “Reset Form” button will clear the information from the screen or form, as at 127. Once a user has entered the information required by the screen or at the option of the user, the user clicks the “Submit Request” button as at 159 to submit the request to the database and then on to the clerk 13b and the prosecutor 13c.

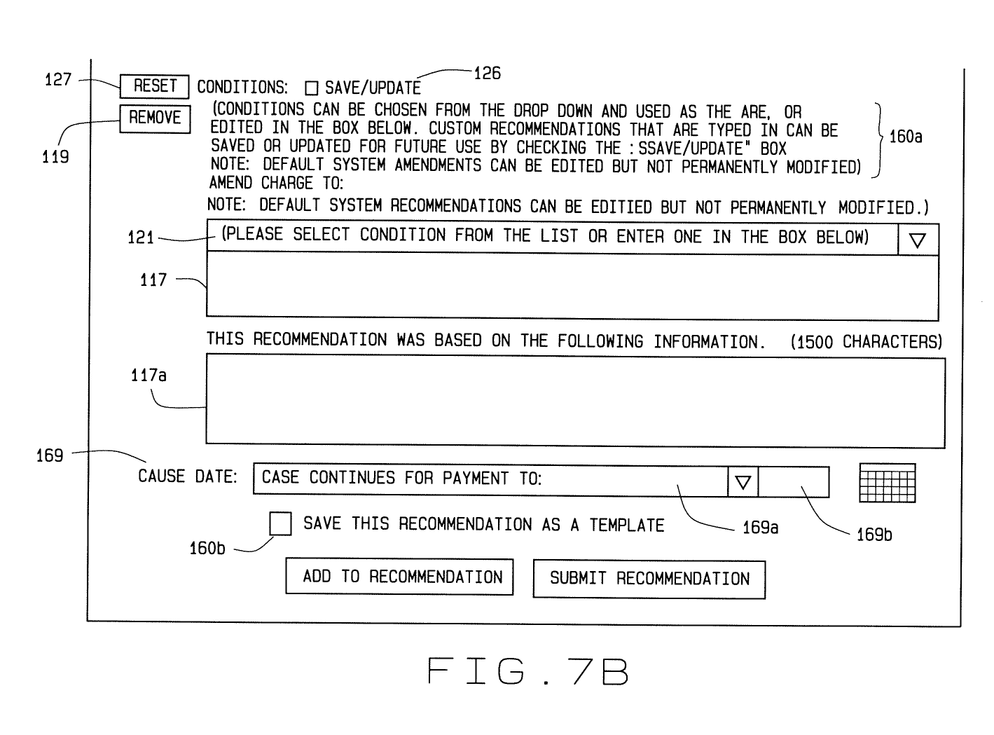

The database then maintains the request for a prosecutor 13c to view upon logging in. Once logged in, a prosecutor views an annotated list of requests as previously shown in FIG. 5. At his discretion, a prosecutor may grant a recommendation to a specific request. The prosecutor clicks upon the line of a request in the list which displays the data of a request from FIG. 6. The prosecutor then clicks a recommend button on the screen using his mouse which displays the screen shown in FIGS. 7A, 7B. FIGS. 7A, 7B show the fields a prosecutor utilizes to create a recommendation for a defendant return to his attorney for review and implementation. Over time, a prosecutor may build a bank of forms or templates for the frequent recommendations issue. The recommendation begins by stating the defendant's name as at 149 towards the top of the screen, shown in FIG. 7A, and with the defendant's attorney's name below it as at 133. The database 10 provides this information as previously entered. Beneath the attorney's name, the screen has the request number 147 selected by the prosecutor. The database provides the charge involved in the request as at 152. The charge appears with its title, ticket number 154, case number 154a, or a None entry. Beneath the charge menu 152, this screen has a templates section as at 160 which allows a prosecutor to select a standard recommendation for a charge which the database will then populate with date upon a recommendation form. The template section operates upon previously created templates. To create a template, a prosecutor 13c proceeds through the fields of the recommendation form after reviewing instructions as at 160a. The instructions include that an amendment can be chosen from a drop down menu 116 and used as they are, or edited in the box 117 below and custom amendments that are typed in can be saved or updated for future use by checking the save update box 126 and a warning that default system amendment may be edited but not permanently modified. The drop down menu or title bar 116 list a title for an amendment and has a text box 117 below that displays the text of an amendment. Beneath the text box, the screen has a check box for the defendant's plea as at 161 to the charge and a check in the box indicates a guilty plea. Beneath the plea box 161, the screen has various remedies allowed for an amendment. The first remedy is jail time as at 162 measured in days selected from a drop down menu or entered from a keyboard. Next is a fine amount as at 163 also selected from a drop down menu or keyboard entry. Then another remedy is to suspend the execution of jail time, fine imposition, or both as at 164. The suspended execution 164 includes a drop down menu as at 164a to indicate a certain number of days in jail, a drop down menu as at 164b to indicate a certain amount of a fine, and a drop down menu as at 164c to indicate the delay time in months before starting jail, fine, or both. Each drop down menu includes an adjacent text box for keyboard entry of an alternate amount. Then another remedy is to suspend imposing a sentence for a certain time as at 165. The suspended imposition includes a dropdown menu to select how many months before a defendant must serve a sentence.

Municipal courts have their operating costs called court costs. The court costs generally fall upon defendants and are adjusted from time to time pursuant to statute and local ordinances. Another remedy is that the defendant pay the court costs as at 166 where a prosecutor clicks a check box to indicate that. The court costs also include a text box for a prosecutor to adjust the court costs amount.

For certain offenses, usually lesser, a prosecutor may exercise a remedy of dismissing a case but upon payment of court costs shown by a check box as at 167. This remedy lists the typical court costs amount but also provides a text box for the prosecutor to adjust the amount. And, a prosecutor upon reviewing the case and following negotiation with the defense attorney may elect not to prosecute a case any further as at 168. Such an election is called a nolle prosequi.

Having reviewed the charge and the various remedies, a prosecutor may save his selections for future use by clicking the save/update box or button as at 126 generally beneath the template box 160 as shown in FIG. 7B. Prosecutors, being people, may have to adjust the components of a recommendation. A prosecutor may do so regarding amending the charge by clicking a reset button as at 127 below the templates line 160. Upon doing so, the database returns the remedies to their default settings and removes all checks from the boxes on this screen. From time to time, a prosecutor may want, or even need, to remove a saved amendment. The prosecutor removes an amendment by clicking the remove button as at 119 immediately below the reset button 127.

Amendments and their remedies may come with conditions. The conditions appear generally below the remedies on this screen in FIG. 7B. FIG. 7B shows the conditions appearing below the nolle prosequi check box as at 168 at the end of FIG. 7A. To create a template for a condition, a prosecutor 13c proceeds over the remedies of the amendment to review a second set of instructions as at 160a. The instructions include that a condition can be chosen from a drop down menu 121 and used as they are, or edited in the box 117 below and custom conditions that are typed in can be saved or updated for future use by checking the save update box 126 and a warning that default system amendment may be edited but not permanently modified. The drop down menu 121 lists a title for a condition with the text box 117 below that displays the text for a condition. The prosecutors may impose conditions on a recommendation within their discretion. The condition may include information or explanation in a supplement text box as at 117a. The supplement text box allows for approximately 1500 additional characters of information.

Once again, having reviewed the condition and its explanation, a prosecutor may the condition for future use by clicking the save/update box or button as at 126 generally beneath the remedies, such as the nolle prosequi check box 168. This save/update box applies solely to conditions. A prosecutor may adjust the components of a condition by clicking a reset button as at 127 below the check box 168. Upon doing so, the database returns the condition to its default setting and removes all text from the supplementary box 117a. From time to time, a prosecutor may want, or even need, to remove a condition entirely and may do so by clicking the remove button as at 119 immediately below the reset button 127 also generally beneath the remedies, such as the nolle prosequi check box 168.

Having selected or set the amendment and any conditions, a prosecutor then moves the case off the active docket and puts it on a docket for resolution as amended. The present invention sends a tickler email to an attorney user for a case and informs him of whether the prosecutor has accepted the request or alternatively rejected the request with a reason. The prosecutor selects a cause date as at 169, beneath the conditions section, and selects either Continue for Payment or Continue for Appearance, as at 169a, and assigns a court date using the adjacent calendar button 169b.

After viewing and completing the above described amendment and condition sections, a prosecutor may save an entire recommendation as a template, see 160, by checking the box for “Save this recommendation as a template” as at 160b at the bottom of the form displayed on a screen. The database then prompts the prosecutor to provide a name and description for the saved recommendation which will appear in the future on the template line as at 160.

Having viewed and completed the above sections or utilized a template, the prosecutor clicks an add to recommendation button as at 137. Clicking this button 137 moves the selections of FIGS. 7A, 7B on to the request 147 in the database. The prosecutor may complete the sections or use a template and add to the recommendation again by clicking the add button 137. Once the recommendation satisfies the prosecutor, the prosecutor clicks a submit recommendation button as at 159 and it doing so prevents alteration of the recommendation for a specific request on the database. The database then collects the information from the request and the recommendation and merges the information into a recommendation suitable for paper printing. The prosecutor reviews the recommendation in this format and if there are no changes, confirms the recommendation. Upon confirmation, the database 10 takes the created document 21 and emails it 24 from the prosecutor 13c to the defense attorney 13a through the messaging subsystem 11. The defense attorney then accesses his account on the web app server 12 through his browser 19 to view the recommendation. The defense attorney then presents the recommendation to his client for acceptance.

From the aforementioned description, a method for lawyers to communicate to courts has been described. The method for lawyers to communicate to courts is uniquely capable of creating recommendations to dispose of municipal offenses electronically and of creating and tracking cases and their documents. The method for lawyers to communicate to courts and its various components may be written in various code languages, including but not limited to, Sharepoint™ by Microsoft® and PDF generating software utilities and with asynchronous Java script XML or AJAX, C++, Visual Basic, UNIX, FORTRAN, COBOL, Assembly, and the like.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like —when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. An interactive system for communicating between courts and users regarding cases, the users including a prosecutor, a court clerk, and an attorney, said system comprising:
a secure internet accessible database upon a computer server, said database receiving electronic communication from at least one user, said database communicating to said at least one user through a web application server and client browser;
said database performing procedures related to creating and to prosecuting a case and performing functions related to creating documents from said at least one user related to a case, said procedures including database backup, and said functions including a calendar; and,
said web application server managing user accounts upon said database and calculating fees due.

2. The interactive communication system for communicating between courts and users of claim 1 further comprising:
said functions providing a template for an attorney user to request a recommendation for a case, a template for a prosecutor user to issue a recommendation for a case, and a screen for a court clerk user to view the status of a case; and,
said procedures providing an index of cases within said database.

3. The interactive communication system for communicating between courts and users of claim 2 further comprising:
said functions providing at least one template for an attorney user to create at least one pleading; and,
said procedures providing an index of cases created by an attorney user.

4. The interactive communication system for communicating between courts and users of claim 2 further comprising:
said template for an attorney user creates at least one pleading; and,
said procedures providing an index of said at least one pleadings created by an attorney user.

5. The interactive communication system for communicating between courts and users of claim 2 further comprising:
said template for a prosecutor user allows annotating a record of a case; and,
said procedures providing an accumulation of forms made by a prosecutor annotating a plurality of cases.

6. The interactive communication system for communicating between courts and users of claim 2 further comprising:
said screen for a court clerk user allows verifying of new cases and associating at least one attorney user to a case; and,
said procedures providing a court clerk user authority to verify security of said system and to reissue passwords to users.

7. The interactive communication system for communicating between courts and users of claim 1 further comprising:
said database communicating in real time to said at least one user; and,
said functions including password recovery for said at least one user.

8. An interactive method for communicating between courts and users regarding cases, the users including a prosecutor, a court clerk, and an attorney, said method comprising:
providing a secure database upon a computer server accessible to the internet;
providing a messaging system in communication with said database;
providing a web application server in communication with said messaging system;
creating at least one user account within said database;
providing at least two functions driven by said database, said functions including document creation by a user and a calendar; and,
operating at least two procedures driven by said database, said procedures including case creation by a user and case indexing.

9. The interactive communication system for communicating between courts and users of claim 8 further comprising:
said operating at least two procedures providing for mutual communication between said users through said database for creation, evaluation, and disposition of cases.

10. The interactive communication system for communicating between courts and users of claim 8 further comprising:
creating at least one template for a document;
extracting data from said database;
populating said at least one template with the extracted data; and,
communicating said at least one template as populated to the users.

11. The interactive communication system for communicating between courts and users of claim 10 further comprising:
said creating at least one template providing for an attorney user at least one pleading; and,
said procedures providing an index of said at least one pleading created by an attorney user.

12. The interactive communication system for communicating between courts and users of claim 10 further comprising:
said creating at least one template providing for a prosecutor user at least annotation of a record of a case; and,
said procedures providing an accumulation of forms made by a prosecutor annotating a plurality of cases.

13. The interactive communication system for communicating between courts and users of claim 10 further comprising:
said creating at least one template providing for a court clerk user at least new case verification and association of at least one attorney user to a case; and,
said procedures providing a court clerk user authority to verify security of said system and to reissue passwords to users.

14. The interactive communication system for communicating between courts and users of claim 8 further comprising:
said database communicating in real time to said at least one user; and,
said functions including password recovery for said at least one user.

15. An interactive method for communicating between courts and users regarding cases, the users including a prosecutor, a court clerk, and an attorney, said method comprising:
providing a secure database upon a computer server in communication over the internet;
providing a messaging system in real time communication with said database;
providing a web application server in real time communication with said messaging system;
creating at least one user account within said database;
providing at least two functions driven by said database, said functions including document creation by a user and a calendar, said document creation including creating at least one template for a document, extracting data from said database, populating said at least one template with the extracted data, and, communicating said at least one template as populated to the users;
operating at least two procedures driven by said database, said procedures including case creation by a user and case indexing, said operating at least two procedures providing for mutual communication between said users through said database for creation, evaluation, and disposition of cases;
said creating at least one template providing for an attorney user at least one pleading, and said procedures providing an index of said at least one pleading created by an attorney user;
said creating at least one template providing for a prosecutor user at least one annotation of a record of a case, and said procedures providing an accumulation of forms made by a prosecutor annotating a plurality of cases; and,
said creating at least one template providing for a court clerk user at least new case verification and association of at least one attorney user to a case, and said procedures providing a court clerk user authority to verify security of said system and to reissue a password to a user.
